(19) United States
(12) Patent Application Publication
(10) Pub. No.: US 2024/0124756 A1
(43) Pub. Date: Apr. 18, 2024

(54) LAMINATED COMPOSITE FILM STRUCTURE

(71) Applicant: Dow Global Technologies LLC, Midland, MI (US)

(72) Inventor: Shailendra Ashok Nagotkar, Mumbai (IN)

(21) Appl. No.: 18/278,314

(22) PCT Filed: Feb. 2, 2022
(86) PCT No.: PCT/US2022/014942

§ 371 Date: Aug. 22, 2023

(30) Foreign Application Priority Data
Mar. 12, 2021 (IN) 202141010437

(51) Int. Cl. C09J 175/06; B32B 7/12; B32B 21/08; B32B 21/14; B32B 27/08; B32B 27/30; B32B 37/12; C08G 18/42; C09J 5/00

(52) U.S. Cl. CPC C09J 175/06; B32B 7/12; B32B 21/08; B32B 21/14; B32B 27/08; B32B 27/304; B32B 37/12; C08G 18/4247; C09J 5/00; B32B 2037/1253; B32B 2250/03; B32B 2255/10; B32B 2255/26; B32B 2307/71; B32B 2307/748; B32B 2309/02; B32B 2317/16; B32B 2327/06; B32B 2375/00; B32B 2419/06; C09J 2400/306; C09J 2427/008; C09J 2475/00

(57) ABSTRACT

A process for producing a multilayer laminated composite film structure including the steps of: (a) applying a solventless polyurethane adhesive composition to at least a first film substrate; wherein the adhesive composition is applied on at least a portion of at least one side surface of the first film substrate to dispose the adhesive composition on at least a portion of the at least one side surface of the first film substrate; (b) contacting the first film substrate of step (a) with at least a second film substrate; wherein the at least one side surface of the first film substrate containing the adhesive composition is in communication with at least one side surface of the second film substrate such that the polyurethane adhesive composition is disposed in between the first and second film substrates; and (c) curing the adhesive composition to bond the first and second substrates together to form a multilayer laminated composite film structure; and a multilayer laminated composite film structure article produced by the above process.

### FIELD

The present invention relates to a laminated composite film structure; and more specifically, the present invention relates to a laminated composite film structure manufactured by bonding various substrates together using a two-component solvent-free polyurethane adhesive composition having enhanced properties.

### BACKGROUND

Heretofore, various two-component (2K) type polyurethane (PU) adhesive compositions have been produced for use in various applications. As is known in the art, 2K PU compositions are based on the reaction mixture of a polyol component and a polyisocyanate component; and have long been used as adhesives. When the two components are mixed, the polyisocyanates and polyols react to form a cured polyurethane adhesive; and the reaction can form a strong adhesive bond to adhere many types of substrates together. For example, the following references disclose a 2K adhesive having good adhesion: U.S. Pat. No. 8,716,427B2; CN104228210(A); CN107614648A; US20140242333 (A1); US20150380695 (A1); US20160204395 (A1); and WO 2015/168670.

While 2K PU adhesive compositions are used in a variety of applications, not all known adhesives work the same, or even work at all, for a particular enduse application. An adhesive must exhibit the proper combination of enhanced properties, such as bond strength and heat resistance, for the adhesive to be used in a particular enduse application. For example, an appropriate lamination adhesive composition, used for bonding two or more substrates together to form a bonded laminated composite film structure, must be carefully selected to function appropriately in the enduse application of the bonded laminated composite film structure. In the roofing industry, for example, a laminated composite film structure manufactured by bonding various known different film substrates together to form a panel structure for use as roofing material, has been attempted with only limited success. Corrugated metal and cement sheets still remain the most widely used roofing materials in low to lower-medium income communities and rural areas all over the world. However, these materials possess discomfort and danger. For example, the materials are susceptible to leakage during the rainy season, extreme heat during summer, and breakage which requires time-consuming repair and timely repair to avoid causing personal injury. Therefore, there is a desire to replace corrugated metal and cement sheets for use as roofing materials.

However, heretofore, it has been challenging to make a suitable laminated panel as an alternative to the known corrugated metal and cement sheets roofing materials. To make a laminated panel that avoids the above problems exhibited by currently known roofing materials, the proper combination of different film substrate materials and the proper adhesive to bond the several different film substrate materials together must be selected to form the laminated panel structure that will function well as a roofing article. In particular, the adhesive is required to possess the proper properties such as a high bond strength, water resistance and heat resistance, to hold the laminate substrates together and to prevent delamination and/or formation of blisters within the laminate panel structure. Especially when the laminated panel structure will be used as roofing material which is exposed to the different elements of weather.

For example, a polyvinyl chloride (PVC) film-faced plywood in combination with a PVC membrane are materials that could be used for roofing applications because such materials can withstand resistance to external weather conditions such as rain water, heat and ultraviolet (UV) rays from sunlight. However, the known adhesives that are used for bonding these types of materials typically do not have the bond strength, water resistance and heat resistance needed to hold the laminate together; and the known adhesives do not prevent the laminate from delaminating and/or forming blisters within the laminate panel when the panel is exposed to the elements for a long period of time. Typically, known panel structures are prepared by using a water-based acrylic adhesive exhibiting an appropriate initial bond strength of 1.5 Kg/25 mm, but the adhesive fails to achieve the required performance of resistance to water, heat and UV sunlight over an extended period of time.

Other laminate structures and methods of preparing such structures are disclosed, for example, in U.S. Pat. Nos. 5,637,171A; 5,449,559A and 5,872,203A; CN107856380A; DE4343468A1; and DE102004051074A1. However, none of the above references disclose a laminate structure having increased water resistance, heat resistance and UV resistance properties; and none of the above references disclose a laminate having no visually observable laminate deformations such as de-lamination, and/or blister formation.

For example, U.S. Pat. No. 5,449,559A discloses a laminating adhesive composition used for bonding PVC to mobile home furniture and paneling. The adhesive used for the bonding is a combination of: a PVOH stabilized vinyl acetate/ethylene copolymer emulsion (e.g., from 50 wt % to 95 wt %), an aqueous polyurethane-acrylic dispersion (e.g., from 5 wt %-50 wt %), and a poly-isocyanate material (e.g., from 3 wt %-15 wt %). The adhesive system disclosed in the above patent becomes water-based upon forming the mixture. The objective of the above patent is to provide an adhesive with: (1) a bond strength of from 1.3 Kg/25 mm to 3.1 Kg/25 mm, (2) a lap sheer that causes no vinyl creep with a 1.8 Kg weight at 71° C. to 93° C., and (3) a cross-hatch shrinkage with a maximum movement of 0.0254 mm at 93° C. The above patent does not disclose an adhesive that provides a laminate structure with an improvement in water resistance, heat resistance, and UV resistance. Further, the above patent does not mention observing a laminate to determine whether the laminate, post-production, develops any laminate deformations such as de-lamination, and/or blister formation. And, the above patent does not provide a solution to laminate deformations such as de-lamination, and/or blister formation if such deformations occur.

Therefore, it would be desirable to manufacture a composite multilayer laminate panel structure that avoids the above problems exhibited by known laminate structures. In particular, it would be desirable to manufacture laminate structures by bonding together various known different film substrates with an adhesive exhibiting the proper advantageous properties to form a panel structure such that the panel structure can be used for roofing materials. For example, it would be desirable to manufacture a composite laminate panel structure such as a PVC film-faced plywood with a PVC membrane. And, it would be desirable to manufacture a laminate panel structure comprising a combination of a PVC film-faced plywood and PVC membrane using a solvent-free adhesive that exhibits proper and advantageous properties such as: (1) water resistance; (2) heat resistance; (3) resistance to UV rays from sunlight; (4) initial bond strength; (5) bond strength retention after exposure to water, heat and UV rays; and (6) resistance to defects such as delamination and blister formation.

### SUMMARY

One embodiment of the present invention is directed to a process for producing a multilayer laminated composite film structure including the steps of: (a) applying a solventless polyurethane adhesive composition to at least a first film substrate; wherein the adhesive composition is applied on at least a portion of at least one side surface of the first film substrate to dispose the adhesive composition on at least a portion of the at least one side surface of the first film substrate; (b) contacting the first film substrate of step (a) with at least a second film substrate; wherein the at least one side surface of the first film substrate containing the adhesive composition is in adhering communication with at least one side surface of the second film substrate such that the polyurethane adhesive composition is disposed in between the first and second film substrates; and (c) curing the adhesive composition to bond the first and second substrates together to form a multilayer laminated composite film structure.

Another embodiment of the present invention is directed to a multilayer laminated composite film structure article made by the above process.

In still another embodiment, the present invention is directed to the use of a solvent-free (or solventless) and water-free, 2K PU lamination adhesive composition for bonding different substrates together to form a multilayer laminated composite film structure such as a laminate panel structure. The 2K PU lamination adhesive composition of the present invention is a two-part system including: (1) a mixture of an isocyanate-terminated urethane part (NCO-component), and (2) a hydroxyl-terminated polyol mixture part (OH-component). The solvent-free PU adhesive composition useful in the present invention is based on polyester polyol which is based on adipic acid with diethylene glycol (DEG) and neopentyl glycol (NPG); having a molecular weight (Mw) of ˜2,000; and which is crosslinked.

In yet another embodiment, the present invention includes the use of a solvent-free 2K PU adhesive composition that exhibits excellent bond strength and defect-free performance with respect to resistance to water, heat and UV rays from sunlight. For example, in some embodiments, the 2K PU adhesive composition in combination with the first and second film substrates used to form the panel structure of the present invention provides, for example, the following performance properties or attributes: (1) a water resistance by dip test of up to 24 hr; (2) a heat resistance under the following conditions: exposure to 80° C. for 30 days @ 8 hr/day; (3) a UV resistance under the following conditions: exposure to sunlight for 30 days @ 8 hr/day; (4) an initial bond strength of ≥1.5 Kg/25 mm; (5) a retention of initial bond strength or greater after exposure to water, heat and UV resistance tests; and (6) no de-lamination or blister formation after exposure to water, heat and UV resistance tests as determined by visual observation.

In some preferred embodiments, the present invention includes the use of a 2K PU adhesive composition for bonding PVC film-faced plywood with PVC membrane forming a bonded laminate panel structure of PVC film-faced plywood with PVC membrane.

In other preferred embodiments, the bonded laminate panel structure of PVC film-faced plywood with PVC membrane is used as a modular roofing system for homes, schools, hospitals and other structures; and therefore, the bonded panel of the present invention is capable of withstanding the elements, viz, when the panel is exposed to external weather conditions such as rain water, heat and UV rays from sunlight.

In still other preferred embodiments, the materials used in making the laminate panel (i.e., plywood, PVC film and PVC membrane) can be manufactured from recycled packaging material and agriculture waste.

### DETAILED DESCRIPTION

Temperatures herein are in degrees Celsius (° C.).

“Room temperature (RT)” and “ambient temperature” herein means a temperature between 23° C. and 27° C., unless specified otherwise.

The term “bond strength” herein means the average force required to peel/separate the two “legs” of a test piece which is subjected to a bond strength test.

The term “de-lamination” herein means a mode of failure where a composite/laminate material fractures or separates into layers.

The term “blister formation” herein means a result of increased pressure from moisture accumulation at certain points in the laminate, while bubbles are typically formed as a result of gas and vapor pressures within the laminate composite.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination. Use of the singular includes use of the plural and vice versa.

The numerical ranges disclosed herein include all values from, and including, the lower and upper value. For ranges containing explicit values (e.g., a range from 1, or 2, or 3 to 5, or 6, or 7), any subrange between any two explicit values is included (e.g., the range 1 to 7 above includes subranges 1 to 2; 2 to 6; 5 to 7; 3 to 7; 5 to 6; and the like).

As used throughout this specification, the abbreviations given below have the following meanings, unless the context clearly indicates otherwise: “=” means “equal(s)” or “equal to”; “<” means “less than”; “>” means “greater than”; “≤” means “less than or equal to”; ≥” means “greater than or equal to”; “@” means “at”; “˜” means “approximately”; “MT”=metric ton(s); g=gram(s); mg=milligram(s); Kg=kilogram(s); Kg/25 mm=kilogram(s) per 25 millimeters; g/L=gram(s) per liter; “g/cm³” or “g/cc”=gram(s) per cubic centimeter; “Kg/m³=kilogram(s) per cubic meter; ppm=parts per million by weight; pbw=parts by weight; min=minute; rpm=revolutions per minute; m=meter(s); mm=millimeter(s); cm=centimeter(s); μm=micron(s), min=minute(s); s=second(s); ms=millisecond(s); hr=hour(s); Pa=pascals; MPa=megapascals; kPa=kilopascal(s); Pa-s=Pascal second(s); mPa-s=millipascal second(s); g/mol=gram(s) per mole(s); g/eq=gram(s) per equivalent(s); Mn=number average molecular weight; Mw=weight average molecular weight; pts=part(s) by weight; 1/s or sec⁻¹=reciprocal second(s) [s⁻¹]; ° C.=degree(s) Celsius; psi=pounds per square inch; g/m² or gsm=gram per square meter; %=percent; vol %=volume percent; mol %=mole percent; and wt %=weight percent.

Unless stated otherwise, all percentages, parts, ratios, and the like amounts, are defined by weight. For example, all percentages stated herein are weight percentages (wt %), unless otherwise indicated.

Specific embodiments of the present invention are described herein below. These embodiments are provided so that this disclosure is thorough and complete; and fully conveys the scope of the subject matter of the present invention to those skilled in the art.

One objective of the present invention is to produce a bonded multi-layer composite laminate panel structure using a solvent-free 2K PU lamination adhesive composition which has excellent bond strength, water resistance, and heat resistance; and does not generate observable lamination deformations such as de-lamination or blister formation when the solvent-free 2K PU lamination adhesive composition is used. For example, in one embodiment, the PU adhesive of the present invention can be used for manufacturing a multi-layer laminate panel structure of PVC film-faced plywood with PVC membrane.

In one general embodiment, the first substrate useful in the present invention can be any polymer film including, for example, a film or membrane of PVC, polyester, aluminum, and a combination of two or more first substrates.

In another general embodiment, the second substrate useful in the present invention can be any polymer film different from the first substrate including, for example, a PVC film-faced plywood, plain plywood, and combinations thereof.

In still another general embodiment, the present invention includes the use of a solventless 2K PU lamination adhesive composition. The adhesive composition used in the present invention can be any conventional solventless 2K PU lamination adhesive composition known to those skilled in the adhesive art. Generally, a 2K PU adhesive includes a reaction mixture of: (A) at least one isocyanate group-containing component; and (B) at least one polyol component (or a hydroxyl group-containing component).

In one embodiment, the 2K PU lamination adhesive useful in the present invention can be formulated by mixing, admixing or blending the isocyanate group-containing component, component (A); and the polyol component, component (B); and any other optional component(s), component (C), if desired.

In another embodiment, the isocyanate group-containing component, component (A), useful for making the adhesive of the present invention can be selected, for example, from the group consisting of an isocyanate monomer, a polyisocyanate (e.g., dimers, trimmers, and the like), an isocyanate prepolymer, and mixtures of two or more thereof. The amount of the isocyanate compound (A) in the adhesive formulation can be generally in the range of from 60 wt % to 80 wt % in one embodiment; from 65 wt % to 75 wt % in another embodiment; from 68 wt % to 70 wt % in still another embodiment; from 66 wt % to 68 wt % in yet another embodiment; and from 70 wt % to 72 wt % in even still another embodiment based on the total weight of the components in the formulation.

The polyol component, component (B), useful for making the adhesive of the present invention can be selected, for example, from the group consisting of at least one polyester polyol compound (e.g., a polyester polyol having a molecule weight of >8,000); at least one phosphate ester polyol compound; at least one prepolymer-polyol-chain extender compound structure such as methylene diphenyl diisocyanate (MDI) end-capped prepolymers based on ethylene oxide (EO) and/or propylene oxide (PO) based diols or triols with an equivalent molecular weight of from 500 g/mol to 1,600 g/mol in the isocyanate component of the adhesive; and ethanediol; and mixtures thereof. The amount of the polyol compound (B) in the adhesive formulation can be generally in the range of from 20 wt % to 40 wt % in one embodiment; from 25 wt % to 35 wt % in another embodiment; from 30 wt % to 32 wt % in still another embodiment; from 29 wt % to 31 wt % in yet another embodiment; and from 31 wt % to 33 wt % in even still another embodiment based on the total weight of the components in the formulation.

As one illustration of the present invention, when component (A) is mixed with component (B), in one preferred embodiment, the ratio of (A):(B), viz, the OH/NCO dry weight index can be from 63 to 100; from 65 to 100 in another embodiment; and from 67 to 100 in still another embodiment.

Although the adhesive useful in the present invention is a two-component adhesive system, as aforementioned, the adhesive formulation may be formulated with a wide variety of optional additives to enable performance of specific functions while maintaining the excellent benefits/properties of the present adhesive product. The optional component(s), component (C), of the polyurethane adhesive may be added to the first isocyanate group-containing component (A); or the optional components of the polyurethane adhesive may be added to the second polyol component (B); or the optional components of the polyurethane adhesive may be added to both the first and second components (A) and (B). For example, in one embodiment, the optional additives, component (C), useful in the formulation may include adhesion promoters such as silane, epoxy and phenolic resin; chain extenders such as glycerin, trimethylol propane, diethylene glycol, propanediol, and 2-methyl-1,3-propanediol; and catalysts such as amines and carboxylates; and mixtures thereof.

The amount of the optional additive(s), component (C), useful for making the adhesive formulation, when used, can be generally from 0 wt % to ≤1 wt % in one embodiment; from 0.1 wt % to 1 wt % in another embodiment; from 0.1 wt % to 0.5 wt % in still another embodiment; and from 0.1 wt % to 0.3 wt % in yet another embodiment based on the total weight of the components in the formulation.

In other embodiments, the solventless 2K PU lamination adhesive useful in the present invention can be selected from commercially available adhesive products. For example, the solventless 2K PU lamination adhesive can be MOR-FREE™ 899A/C-99, PACACEL™ 968/C-108, and MOR-FREE™ 698AG/C-411; all solvent-free polyurethanes adhesives (available from The Dow Chemical Company).

The adhesive formulation used in the present invention has several advantageous properties and benefits when used in combination with, and to bond, the first and second substrates together. For example, some of the properties exhibited by the adhesive formulation can include: (1) a sufficient water resistance; (2) a sufficient heat resistance; (3) a sufficient UV resistance; (4) an increase in initial bond strength (i.e., increasing the bond strength of the adhesive from the initial bond strength of the adhesive) after the polyurethane adhesive composition is subjected to the water resistance dip test, the heat resistance test, and the UV resistance test; (5) a retention of bond strength (i.e. maintaining the bond strength of the adhesive to as close as possible to the initial bond strength of the adhesive) after the polyurethane adhesive composition is exposed to the water resistance dip test, the heat resistance test, and the UV resistance test; and/or (6) no visual observation of de-lamination or blister formation of the multilayer laminated composite film structure after the multilayer laminated composite film structure with the polyurethane adhesive composition is exposed to the water resistance test, the heat resistance test, and the UV resistance test.

For example, in one general embodiment, the initial bond strength of the polyurethane adhesive composition is generally ≥1.5 Kg/25 mm. An initial bond strength value lower than 1.5 Kg/25 mm may cause defects in the laminated composite film structure such as delamination and/or blister formation. There is no upper limit to the initial bond strength value of the adhesive, as the higher the initial bond strength the better for the adherence of the layers of the laminated composite film structure. Advantageously, the maintenance of the 1.5 Kg/25 mm bond strength or greater of the adhesive in the composite film structure of the present invention continues after the polyurethane adhesive composition/composite laminate is exposed to the water resistance dip test of up to 24 hr, the heat resistance test of 80° C. for 30 days at 8 hr/day, and the UV resistance test of exposure to sunlight for 30 days at 8 hr/day. A decrease in the bond strength value of the adhesive can cause defects in the composite film structure such as delamination and/or blister formation.

In other embodiments, the multilayer laminated composite film structure of the present invention is not susceptible to laminate damage, such as de-lamination, blister formation, or both; after the multilayer laminated composite film structure with the polyurethane adhesive composition is exposed to the water resistance test, the heat resistance test, and the UV resistance test. For example, the multilayer laminated composite film structure of the present invention does not de-laminate and/or forms blisters, as determined by visual observation by the naked eye, after the multilayer laminated composite film structure with the polyurethane adhesive composition is exposed to the water resistance dip test, the heat resistance test, and the UV resistance test.

In a general embodiment, the process of the present invention for producing the multilayer laminated composite film structure includes the steps of:
(a) applying a solventless polyurethane adhesive composition to at least a first film substrate; wherein the adhesive composition is applied on at least a portion of at least one side surface of the first film substrate to dispose the adhesive composition on at least a portion of the at least one side surface of the first film substrate;
(b) contacting the first film substrate of step (a) with at least a second film substrate; wherein the at least one side surface of the first film substrate containing the adhesive composition contacts at least one side surface of the second film substrate such that the polyurethane adhesive composition is in adherence communication with the at least one side surface of the second film substrate and the adhesive composition is disposed between the first and second film substrates; and
(c) curing the adhesive composition to bond the first and second substrates together to form a multilayer laminated composite film structure.

In the application step (a) of the above process, the solventless polyurethane adhesive composition is applied to the first film substrate at a temperature of, for example, from 23° C. to 27° C. such that the adhesive composition is disposed on at least a portion of at least one side surface of the first film substrate.

After the solventless polyurethane adhesive composition is applied to the first film substrate in step (a), the adhesive side of the first film substrate is contacted with a second film substrate in the contacting step (b) of the process at a temperature of, for example, from 23° C. to 27° C., to dispose the polyurethane adhesive composition in between the first and second film substrates such that the adhesive composition is sandwiched between the two (first and second) substrates. The sandwiched adhesive layer between the two substrates forms a multilayer composite film structure.

The composite film structure with the adhesive layer resulting after step (b), is then allowed to cure in the curing step (c) of the process at a temperature of, for example, from 23° C. to 27° C. Curing the adhesive composition, in turn, bonds the first and second substrates together to form a multilayer laminated composite film structure.

The application/contacting step (a) of the process can be carried out by conventional procedures and equipment known to those skilled in the art including for example a K-Bar coater/brush. The amount of adhesive is applied to the first substrate to form an adhesive coating layer having a coating weight of, for example, from 10 gsm up to 70 gsm in one general embodiment, from 20 gsm to 60 gsm in another embodiment, and from 30 gsm to 50 gsm in still another embodiment.

The substrates, in the contacting/application step (b) of the process, are brought together by pressing the adhesive coated PVC film, with the adhesive coating side, contacting the surface of the second substrate, i.e., to cover the film-faced plywood. For example, a roller of 2 Kg weight is rolled over the composite laminate to apply a uniform pressure on the laminate and to develop the bond strength via the adhesive disposed inbetween the first and second substrates.

After the contacting step (b) of the process is carried out, the bonded substrates forming the laminate is allowed to cure at RT (25° C.±2° C.). Curing of the adhesive is usually complete after 72 hr. Once the adhesive cures for 72 hr and the substrates are bonded together, the resultant multilayer laminated composite film structure can be tested for bond strength. To test the resultant multilayer laminated composite film structure for water resistance, heat resistance, and UV resistance, the adhesive is allowed to cure for 7 days; and once curing of the adhesive is completed after 7 days, the film structure is subjected to the water, heat, and UV resistance tests.

The multilayer laminated composite film structure manufactured by the process of the present invention comprises a bonded laminate panel structure such as a PVC film-faced plywood and PVC membrane bonded together with the 2K PU adhesive composition forming a bonded laminate panel structure of PVC film-faced plywood with PVC membrane; and such bonded laminate panel structures can be used in various applications. In some embodiments, the bonded laminate panel structure of PVC film-faced plywood with PVC membrane may be used, for example, as a modular roofing system for homes, schools, hospitals and other buildings or other structures. When the panel is used in roofing applications, the bonded panel advantageously exhibits sufficient initial bond strength, water resistance; heat resistance; UV resistance, and retention of bond strength when the panel is exposed to external weather conditions such as rain water, heat and UV rays from sunlight. In addition, the multilayer laminated composite film structure used as roofing material beneficially shows no visual signs of de-lamination or blister formation after the multilayer laminated composite film structure with the polyurethane adhesive composition is exposed to external weather conditions such as rain water, heat and UV rays from sunlight. In other embodiments, the multilayer laminated composite film structure manufactured by the process of the present invention can be used in other applications required a structure having a strong bond.

In still other embodiments, the multilayer laminated composite film structure manufactured by the process of the present invention can be manufactured using materials (i.e., plywood, PVC film and PVC membrane) comprising recycled packaging material and agriculture waste. Thus, environmental waste can be reduced by employing the recycled materials to make the multilayer laminated composite film structure of the present invention.

### Examples

The following Inventive Examples (Inv. Ex.) and Comparative Examples (Comp. Ex.) (collectively, “the Examples”) are presented herein to further illustrate the features of the present invention but are not intended to be construed, either explicitly or by implication, as limiting the scope of the claims. The Inventive Examples of the present invention are identified by Arabic numerals and the Comparative Examples are represented by letters of the alphabet. The following experiments analyze the performance of embodiments of compositions described herein. Unless otherwise stated all parts and percentages are by weight on a total weight basis.

### General Procedure for Preparing Substrates

A first substrate comprising a PVC membrane is bonded to a second substrate comprising a PVC film-faced plywood substrate using the adhesives (Adh.1-Adh.7) described in Table I where each one of the adhesives is disposed in between the first and second substrates. Before applying the first substrate to the second substrate, the PVC film-faced plywood second substrate is slightly scuffed (on the PVC film surface of the second substrate) with emery paper to make the surface of the second substrate more receptive to the adhesive contacting the scuffed surface for better adhesion with the PVC membrane first substrate. Thereafter, each of the adhesives (described in Table I) is first applied to the PVC membrane, and then, the PVC membrane containing the adhesive coating is applied to the scuffed surface of the second substrate by contacting the adhesive coating side (surface) of the first substrate to the scuffed surface of the second substrate.

TABLE I
Adhesives

| Adhesive | | Brief | |
|---|---|---|---|
| (Adh.) | | Description | |
| No. | Adhesive Product | of Adhesive | Supplier |
| Adh. 1 | Water-based pressure | Water-based | Astra |
| | sensitive adhesive | acrylic | |
| Adh. 2 | ROBOND ™ PS-90 | Water-based | The Dow |
| | | acrylic | Chemical |
| | | | Company |
| | | | (Dow) |
| Adh. 3 | ADCOTE ™ 548-81R/ | Solvent-based PU | Dow |
| | Coreactant F-854 | | |
| Adh. 4 | LOCTITE LIOFOL LA7728/ | Solvent-free PU | Henkel |
| | LOCTITE LIOFOL LA 6028 | | |
| Adh. 5 | MOR-FREE ™ 899A/ | Solvent-free PU | Dow |
| | MOR-FREE ™ C-99 | | |
| Adh. 6 | PACACEL ™968/ | Solvent-free PU | Dow |
| | PACACEL ™C-108 | | |
| Adh. 7 | MOR-FREE ™ 698AG/ | Solvent-free PU | Dow |
| | MOR-FREE ™ C-411 | | |

### General Procedure for Coating First Substrate

The adhesives (Adh.1-Adh.7) described in Table I are coated on the surface of one side of a PVC membrane using a lab scale K-Bar coater and using the coating process parameters described in Table II.

TABLE II
Coating Process Parameters

| | Adhesive No.: | | | | | | |
|---|---|---|---|---|---|---|---|
| | Adh.1 | Adh.2 | Adh.3 | Adh.4 | Adh.5 | Adh.6 | Adh.7 |
| | Adhesive: | | | | | | |
| | Water- | | | LOCTITE | MOR- | | MOR- |
| | based | | | LIOFOL | FREE ™ | | FREE ™ |
| | pressure | | ADCOTE ™ | LA7728/ | 899A/ | PACACEL ™ | 698AG/ |
| | sensitive | | 548-81R/ | LOCTITE | MOR- | 968/ | MOR- |
| | adhesive | ROBOND ™ | Coreactant | LIOFOL | FREE ™ | PACACEL ™ | FREE ™ |
| | (existing) | PS-90 | F-854 | LA6028 | C-99 | C-108 | C-411 |
| Mixing ratio: | N.A.* | N.A. | 100:11:136 | 100:80 | 100:50 | 100:45 | 100:40 |
| Solvent used | N.A. | N.A. | Ethyl | N.A. | N.A. | N.A. | N.A. |
| for dilution: | | | Acetate | | | | |
| Adhesive gsm | 32, 26 | 23, 29 | 69, 87 | 72, 85 | 81, 68 | 78, 62 | 65, 73 |
| (dry) | | | | | | | |
| For 2 samples | | | | | | | |

Notes for Table II:
*“N.A.” = not applicable.

### Comparative Examples A-E and Inventive Examples 1 and 2

### General Procedure for Preparing Laminate Panels

Each of the adhesive-coated PVC membranes prepared as described above is pressed onto the top surface of a film-faced plywood substrate to form a panel comprising a coated film-faced plywood/PVC membrane. The coated panels are stacked on top of each other and an additional weight (an object weighing 5 Kg) is placed on top of the stack of panels to maintain sufficient pressure on the coated panels for up to 24 hr. The coated panels are then allowed to cure for 24 hr at RT.

After the coated panels are cured for 24 hr at RT as described above, the cured coated panels are subjected to the following test methods.

### Test Methods

The following tests were conducted to check the performance of bonded panels. The dimensions of the samples of bonded panels used in each of the test methods which follow were 200 mm in length×150 mm in width with a thickness of 12.7 mm. The thickness of 12.7 mm for a bonded panel is a combination of the thickness of the film-faced plywood which is 12 mm thick and the thickness of the PVC membrane which is 0.7 mm thick. For each of the water, heat and UV resistance tests, a rating system was used to rate the performance of the bonded panels with regard to development of surface defects, such as delamination and/or blister formation, after the bonded panels are subjected to water resistance, heat resistance and UV resistance tests.

The rating system is based on visual observation with the naked eye for the presence/extent of delamination/blistering of the bonded panels after the bonded panels are subjected to water resistance, heat resistance and UV resistance tests; and the rating system used is as follows: a rating of “1” means the panel exhibits “no” surface defects (i.e., no delamination and no blister formation), a rating of “2” means the panel exhibits “minor” surface defects (i.e., some delamination and/or some blister formation and the panel is not useful to its full extent), and a rating of “3” means the panel exhibits “major” surface defects (i.e., an excessive amount of delamination and blister formation is observed and thus the bonded panel fails and is not useful).

### Bond Strength Test

An Instron Material Testing machine is used for bond strength testing of the panels. The machine and its software icon, MERLIN (bond strength testing data storage), are turned on. Grip screws on the machine are released by manually pressing switches just next to each gripper or by pressing a foot paddle. Using a cutter, a straight cut is marked on the panel surface (on the surface of PVC membrane side). The length of the cut is 200 mm and the width of the cut is 25 mm. The bonded panel is delaminated up to a length of 50 mm; and then the panel is mounted on the machine between the two grips with the film-faced plywood fixed on the lower grip and PVC membrane fixed on the upper grip. This makes an angle of 180°. The extension and load on the machine are set to “zero”. The machine is then started and set at a speed of 50 mm/min. The readings from the machine are recorded and reported in Kg/25 mm.

The desired results from the above bond testing method are to produce an adhesive that provides a required minimum Initial Bond Strength of ≥1.5 Kg/25 mm; and a retention of good bond strength after exposure to the water, heat and UV resistance tests described herein below in the present disclosure.

### Water Resistance Test

Water is added into a plastic bucket at ¾^{th} volume of the bucket. Using a dip test, the bonded panels are immersed in the water in such a way that the panels are surrounded by water from all sides of the panels, continuously for 24 hr. After 24 hr, the panels are observed visually with the naked eye for any signs of developed defects such as delamination and blister formation. The test temperature is 25° C.

The desired results from the above water resistance testing method are to produce an adhesive that provides a retention of good bond strength after exposure to the water resistance test described in the present disclosure; and no de-lamination and no blister formation should be visually observed on the bonded panels after the panels are exposed to the water resistance test.

### Heat Resistance Test

A hot air oven is set at 80° C.; and the bonded panels are placed inside of the oven and kept in the oven for 30 days. After 30 days of exposure to the 80° C. heat @ 8 hr/day, the panels are visually observed with the naked eye for any defects developed after the above heat exposure. The defects to look for in the panels include, for example, de-lamination and/or blister formation.

The desired results from the above heat resistance testing method are to produce an adhesive that provides a retention of good bond strength after exposure to the heat resistance test described in the present disclosure; and no de-lamination and no blister formation after exposure to the heat resistance test.

### UV Resistance Test

Bonded panels are kept outdoors in the external environment and are exposed to the UV rays from the sunlight. After 30 days of exposure to the sunlight @ 8 hr/day, the panels are visually observed with the naked eye for any defects developed after the above UV exposure. The defects to look for in the panels include, for example, de-lamination and/or blister formation.

The desired results from the above UV resistance testing method are to produce an adhesive that provides a retention of good bond strength after exposure to the UV resistance test described in the present disclosure; and no de-lamination and no blister formation after exposure to the UV resistance test.

### Test Results

The performance results of the bonded panels were obtained by carrying out the above tests on the bonded panels at respective coating weights of the adhesive. The test results for initial bond strength are described in Table III and the overall results for the tests performed on the panels are described in Table IV.

TABLE III
Initial Bond Strength Results

| Example No.: | | | | | | |
|---|---|---|---|---|---|---|
| Comp. | Comp. | Comp. | Comp. | Comp. | Inv. Ex. | Inv. Ex. |
| Ex. A | Ex. B | Ex. C | Ex. D | Ex. E | 1 | 2 |
| Adhesive No.: | | | | | | |
| Adh.1 | Adh.2 | Adh.3 | Adh.4 | Adh.5 | Adh.6 | Adh.7 |
| Adhesive Used: | | | | | | |
| | | | LOCTITE | MOR- | | MOR- |
| Water-based | | | LIOFOL | FREE ™ | | FREE ™ |
| pressure | | ADCOTE ™ | LA7728/ | 899A/ | PacAcel ™ | 698AG/ |
| sensitive | | 548-81R/ | LOCTITE | MOR- | 968/ | MOR- |
| adhesive | ROBOND ™ | Coreactant | LIOFOL | FREE ™ | PacAcel ™ | FREE ™ |
| (existing) | PS-90 | F-854 | LA6028 | C-99 | C-108 | C-411 |

Results at First Adhesive Concentration

| | | | | | | | |
|---|---|---|---|---|---|---|---|
| Adhesive, gsm (dry) | 32, 26 | 23, 29 | 28, 34 | 40, 32 | 30, 36 | 35, 40 | 32, 38 |
| for 2 samples: | | | | | | | |
| Bond Strength (Initial), | 1.5-1.6 | 0.4-0.5 | 0.4-0.6 | 0.5-0.7 | 0.4-0.6 | 1.1-1.3 | 1.2-1.4 |
| Kg/25 mm: | | | | | | | |

Results at Second Adhesive Concentration

| | | | | | | | |
|---|---|---|---|---|---|---|---|
| Adhesive, gsm | 32, 26 | 23, 29 | 69, 87 | 72, 85 | 81, 68 | 78, 62 | 65, 73 |
| for 2 samples: | | | | | | | |
| Bond Strength (Initial), | 1.5-1.6 | 0.4-0.5 | 0.6-0.8 | 0.8-1.0 | 0.7-0.9 | 1.8-2.0 | 1.5-1.8 |
| Kg/25 mm: | | | | | | | |

TABLE IV
Overall Test Results for Panels

| | Example No.: | | | |
|---|---|---|---|---|
| | Comp. | Comp. | Comp. | Comp. |
| | Ex. A | Ex. B | Ex. C | Ex. D |
| | Adhesive No.: | | | |
| | Adh. 1 | Adh. 2 | Adh. 3 | Adh. 4 |
| Adhesive Used: | Water- | ROBOND ™ | ADCOTE ™ | LOCTITE |
| | based | PS-90 | 548-81R/ | LIOFOL |
| | pressure | | Coreactant | LA7728/ |
| | sensitive | | F-854 | LOCTITE |
| | adhesive | | | LIOFOL |
| | (existing) | | | LA6028 |
| Bond Strength | 1.5-1.6 | 0.4-0.5 | 0.6-0.8 | 0.8-1.0 |
| (Initial), Kg/ | | | | |
| 25 mm: | | | | |
| Water Resistance: | Yes | Yes | No | No |
| Observation and | Delamin- | Delamin- | Delamin- | Delamin- |
| Rating*: | ation/ | ation/ | ation/ | ation/ |
| | Yes | Yes | No | No |
| | Blistering | Blistering | Blistering | Blistering |
| | 3 | 3 | 1 | 2 |
| Bond Strength | 0.1-0.2 | 0.2-0.3 | 0.4-0.5 | 0.2-0.3 |
| After Water | | | | |
| Resistance | | | | |
| Test, Kg/25 mm: | | | | |
| Heat Resistance: | No | No | No | No |
| Observation and | Delamin- | Delamin- | Delamin- | Delamin- |
| Rating*: | ation/ | ation/ | ation/ | ation/ |
| | No | No | No | No |
| | Blistering | Blistering | Blistering | Blistering |
| | 2 | 2 | 1 | 1 |
| Bond Strength | 0.6-0.8 | 0.3-0.4 | 0.5-0.6 | 0.3-0.4 |
| After | | | | |
| Heat Resistance | | | | |
| Test, Kg/25 mm: | | | | |
| UV Resistance: | No | No | No | No |
| Observation and | Delamin- | Delamin- | Delamin- | Delamin- |
| Rating*: | ation/ | ation/ | ation/ | ation/ |
| | No | No | No | No |
| | Blistering | Blistering | Blistering | Blistering |
| | 1 | 1 | 1 | 1 |
| Bond Strength | 0.3-0.4 | 0.1-0.2 | 0.2-0.3 | 0.2-0.3 |
| After UV | | | | |
| Resistance Test, | | | | |
| Kg/25 mm: | | | | |

TABLE IV
Overall Test Results for Panels (cont.)

| | Example No.: | | |
|---|---|---|---|
| | Comp. Ex. E | Inv. Ex. 1 | Inv. Ex. 2 |
| | Adhesive No.: | | |
| | Adh. 5 | Adh. 6 | Adh. 7 |
| Adhesive Used: | MOR- | PacAcel ™ | MOR- |
| | FREE ™ | 968/ | FREE ™ |
| | 899A/ | PacAcel ™ | 698AG/ |
| | MOR- | C-108 | MOR- |
| | FREE ™ | | FREE ™ |
| | C-99 | | C-411 |
| Bond Strength | 0.7-0.9 | 1.8-2.0 | 1.5-1.8 |
| (Initial), Kg/25 mm: | | | |
| Water Resistance: | No | No | No |
| Observation | Delamination/ | Delamination/ | Delamination/ |
| and Rating*: | No | No | No |
| | Blistering | Blistering | Blistering |
| | 2 | 1 | 1 |
| Bond Strength After | 0.2-0.3 | 1.5-1.6 | 1.4-1.6 |
| Water Resistance | | | |
| Test, Kg/25 mm: | | | |
| Heat Resistance: | No | No | No |
| Observation | Delamination/ | Delamination/ | Delamination/ |
| and Rating*: | No | No | No |
| | Blistering | Blistering | Blistering |
| | 1 | 1 | 1 |
| Bond Strength After | 0.3-0.4 | 1.6-1.8 | 1.7-2.0 |
| Heat Resistance | | | |
| Test, Kg/25 mm: | | | |
| UV Resistance: | No | No | No |
| Observation and | Delamination/ | Delamination/ | Delamination/ |
| Rating*: | No | No | No |
| | Blistering | Blistering | Blistering |
| | 1 | 1 | 1 |
| Bond Strength After | 0.2-0.3 | 1.7-1.8 | 1.5-1.8 |
| UV Resistance Test, | | | |
| Kg/25 mm: | | | |

Notes
for Table IV:
*Rating based on visual observation for the presence/extent of delamination/blistering of the 5 laminated film structure after the laminated film structure (i.e., the bonded panel) is subjected to water resistance, heat resistance and UV resistance tests:
“1” = Good,
“2” = Satisfactory, and
“3” = Bad.

### Discussion of Results

### Initial Bond Strength

As shown in Tables III and IV, the initial bond strength of all of the adhesives/panels (except the adhesive/panel of Comp. Ex. A) do not achieve a minimum required initial bond strength of 1.5 Kg/25 mm at an adhesive coating weight of ˜30 gsm to 40 gsm. Therefore, adhesive coating weight is increased for the adhesives/panels of Comp. Ex. C-E and Inv. Ex. 1 and 2; and the adhesives/panels are re-tested to check if any change in initial bond strength occurs. The adhesive/panels prepared in Inv. Ex. 1 (PACACEL™ 968/PACACEL™ C-108, Adh.6) and the adhesive/panels prepared in Inv. Ex. 2 (MOR-FREE™ 698AG/MOR-FREE™ C-411, Adh.7) achieved the minimum required level of 1.5 Kg/25 mm.

### Water Resistance

As shown in Tables III and IV, after the adhesives/panels are subjected to the water resistance, heat resistance and UV resistance tests, the existing known water-based adhesive/panel of Comp. Ex. A (Adh.1) and the water-based adhesive/panel of Comp. Ex. B (ROBOND™ PS-90, Adh.2) exhibit poor water resistance, whereas the water-based adhesive/panel of Comp. Ex. D (LOCTITE LIOFOL LA 7728/LOCTITE LIOFOL LA 6028, Adh.4) and the water-based adhesive/panel of Comp. Ex. E (MOR-FREE™ 899A/MOR-FREE™ C-99, Adh.5), show some moderate/satisfactory water resistance while the water-based adhesive/panel of Comp. Ex. C (ADCOTE™ 548-81R/Coreactant-F, Adh.3) shows good water resistance with no auto delamination/blistering in the panel. The water-based adhesive/panel of Inv. Ex. 1 (PACACEL™968/PACACEL™ C-108, Adh.6), and the water-based adhesive/panel of Inv. Ex. 2 (MOR-FREE™ 698AG/MOR-FREE™ C-411, Adh.7) also show good water resistance with no auto delamination/blistering in the panel.

### Heat Resistance

As shown in Tables III and IV, after the adhesives/panels are subjected to the water resistance, heat resistance and UV resistance tests, the existing known water-based adhesive/panel of Comp. Ex. A (Adh.1) and the water-based adhesive/panel of Comp. Ex. B (ROBOND™ PS-90, Adh.2) exhibit some moderate/satisfactory heat resistance while the water-based adhesives/panels of Comp. Ex. C (ADCOTE™ 548-81R/Coreactant-F, Adh.3), Comp. Ex. D (LOCTITE LIOFOL LA 7728/LOCTITE LIOFOL LA 6028, Adh.4), and Comp. Ex. E (MOR-FREE™ 899A/MOR-FREE™ C-99, Adh.5), show good heat resistance with no auto delamination/blistering in the panel. The water-based adhesive/panel of Inv. Ex. 1 (PACACEL™968/PACACEL™ C-108, Adh.6), and the water-based adhesive/panel of Inv. Ex. 2 (MOR-FREE™ 698AG/MOR-FREE™ C-411, Adh.7) also show good heat resistance with no auto delamination/blistering in the panel.

### UV Resistance

As shown in Tables III and IV, after the adhesives/panels are subjected to the water resistance, heat resistance and UV resistance tests, all of the adhesives/panels prepared in Comp. Ex. A-E and Inv. Ex. 1 and 2 show good UV resistance with no delamination/blistering in the panel.

### Bond Strength Retention After Water/Heat/UV Resistance Tests

As shown in Tables III and IV, after the adhesives/panels are subjected to the water resistance, heat resistance and UV resistance tests, the bond strength retention of all of the adhesives/panels of all of the Examples is measured. The adhesive/panel prepared in Inv. Ex. 1 (PACACEL™968/PACACEL™ C-108, Adh.6) and the adhesive/panel prepared in Inv. Ex. 2 (MOR-FREE™ 698AG/MOR-FREE™ C-411, Adh.7) show an excellent bond strength retention property compared to all of the other adhesive/panels of Comp. Ex. A-E.

### Overall Performance

Using solvent-free (i.e., water-based) adhesives such as PACACEL™968/PACACEL™ C-108 (Inv. Ex. 1) and MOR-FREE™ 698AG/MOR-FREE™ C-411 (Inv. Ex. 2) to prepare a panel, provides an adhesive/panel structure that exhibits excellent performance with respect to Initial Bond Strength. And, there is no observable delamination/blister formation in the panels of Inv. Ex. 1 and 2 after exposure to the water resistance, heat resistance and UV resistance tests. The results from the Bond Strength Retention test show that the bond strength of the adhesives/panels of Inv. Ex. 1 and 2 is good and maintained close to the initial bond strength after the adhesive/panels of Inv. Ex. 1 and 2 are exposed to the water resistance, heat resistance and UV resistance tests. The results described in Tables III and IV show that the panels constructed with the adhesives of Inv. Ex. 1 (PACACEL™968/PACACEL™ C-108, Adh.6) and Inv. Ex. 2 (MOR-FREE™ 698AG/MOR-FREE™ C-411, Adh.7) have a rating of “1” in all three resistance tests (water, heat, UV) while Comp. Ex. A-E have a rating of “2” and/or “3” in at least one of the three resistance tests. Based on the results described in Tables III and IV, the panels constructed with the adhesives of Inv. Ex. 1 and Inv. Ex. 2 are surprisingly differentiated from all of the other adhesive/panel products of Comp. Ex. A-E.

What is claimed is:

1. A process for producing a multilayer laminated composite film structure comprising the steps of:
(a) applying a solventless polyurethane adhesive composition to at least a first film substrate; wherein the adhesive composition is applied on at least a portion of at least one side surface of the first film substrate to dispose the adhesive composition on at least a portion of the at least one side surface of the first film substrate;
(b) contacting the first film substrate of step (a) with at least a second film substrate; wherein the at least one side surface of the first film substrate containing the adhesive composition contacts at least one side surface of the second film substrate such that the polyurethane adhesive composition is in communication with the at least one side surface of the second film substrate and the adhesive composition is disposed between the first and second film substrates; and
(c) curing the adhesive composition to bond the first and second substrates together to form a multilayer laminated composite film structure.

2. The process of claim 1, wherein the polyurethane adhesive composition has: (1) an initial bond strength of greater than or equal to 1.5 kilograms per 25 millimeters.

3. The process of claim 1, wherein the polyurethane adhesive composition has a retention of bond strength of greater than or equal to 1.5 kilograms per 25 millimeters after the polyurethane adhesive composition is exposed to a water resistance dip test of up to 24 hours, a heat resistance test at a temperature of 80° C. for 30 days at 8 hours per day, and a UV resistance test at sunlight exposure for 30 days at 8 hours per day.

4. The process of claim 1, wherein the polyurethane adhesive composition has no visual observation of de-lamination or blister formation of the multilayer laminated composite film structure after the multilayer laminated composite film structure with the polyurethane adhesive composition is exposed to a water resistance dip test of up to 24 hours, a heat resistance test at a temperature of 80° C. for 30 days at 8 hours per day, and a UV resistance test at sunlight exposure for 30 days at 8 hours per day.

5. The process of claim 1, wherein the polyurethane adhesive composition is a polyester polyol based on adipic acid with diethylene glycol and neopentyl glycol.

6. The process of claim 1, wherein the first film substrate is a polyvinyl chloride membrane substrate.

7. The process of claim 1, wherein the second film substrate is a polyvinyl chloride film-faced plywood substrate.

8. The process of claim 1, wherein the contacting step (a), the contacting step (b), and the curing step (c) are carried out at a temperature of from 23° C. to 27° C.

9. A multilayer laminated composite film structure made by the process of claim 1.

10. The multilayer laminated composite film structure of claim 9; wherein the multilayer laminated composite film structure is a laminated panel article for use in roofing applications.
